(19) United States
(12) Patent Application Publication
(10) Pub. No.: US 2008/0036361 A1
(43) Pub. Date: Feb. 14, 2008

(54) Flat field emission illumination module

(75) Inventors: Woo-Hu Tsai, Taipei City (TW); Ming-Chung Fan, Taipei City (TW); Jung-Chien Chang, Taoyuan City (TW)

Correspondence Address: BACON & THOMAS, PLLC, 625 SLATERS LANE, FOURTH FLOOR, ALEXANDRIA, VA, 22314, US

(73) Assignees: Forward Electronics Co., Ltd., Taipei City (TW); Tatung Company, Taipei City (TW)

(21) Appl. No.: 11/889,097

(22) Filed: Aug. 9, 2007

(30) Foreign Application Priority Data
Aug. 9, 2006 (TW) 095129179

(51) Int. Cl. H01J 1/62

(52) U.S. Cl. 313/496

(57) ABSTRACT

A flat field emission illumination module comprises a top substrate; a bottom substrate including a plurality of cathodes and of electron emitters, wherein the cathodes are located on the top surface of the bottom substrate and the electron emitters are mounted on the cathodes; an anode interposed between the top and bottom substrates, where the anode is provided at its bottom surface with a plurality of grooves or openings, and where the electron emitters, after assembly of the flat field emission illumination module, are accommodated in the grooves or the openings; and an illumination layer positioned at the inner surface of the grooves or openings, so as to enhance a cooling effect of field emission backlight modules, to raise the illumination efficiency of the illumination module, and to reduce the difficulty in packaging of the module.

### BACKGROUND OF THE INVENTION

1. Field of the Invention

The present invention relates to flat field emission illumination modules, more particularly to a flat field emission illumination module adapted to displays or common flat illumination facilities.

2. Description of Related Art

Electronic display screens have become ubiquitous in modern life, and televisions, cellular phones, personal digital assistants (PDA), digital cameras, let alone computers etc, rely on controlling displays to transmit information. In contrast to the traditional Cathode Ray Tube (CRT) displays, new generation flat panel displays are superior as far as being lightweight, compact and benign to human health are concerned. However, there still are problems to be solved in terms of brightness, power consumption, and so forth.

Among newly developed technologies for flat panel displays, liquid crystal displays (LCDs) are currently adopted as the main trend. Due to the fact that LCDs are not the kind of displays that self illuminate, an external light source is required in order to produce a display function. A backlight module, therefore, plays the role of light source, and has become one of the essential elements for LCDs.

Conventional displays adopt a cold cathode fluorescent light (CCFL) as a backlight for illuminating flat panel displays. Nevertheless, there are shortcomings in the CCFL, such as short life, more power consumption, undesirable colorfulness on the surface, and containing mercury that is very harmful to the environment. Moreover, because of the configuration of the light tube, the backlight module of a display usually needs to be incorporated with a light guide plate, a light reflector, and a diffuser so as to make uniform the light beams emitted from the light. In other words, taking the CCFL as a light source for a backlight module, in addition to incorporating with the above-mentioned auxiliary elements, requires a certain thickness of spacing for uniformly diffusing the light source, so that a uniform illumination light beam for the LCD panel can be obtained. This, however, makes a rather strict limitation on the application of a backlight module.

Alternatively, a light emitting diode (LED) backlight module can be adopted for LCDs in terms of illumination. The LED has its merits of low power consumption, high brightness output, and compact size. However, because the light beam of an LED is introduced directly into the sides of a light guide plate, a non-uniform band of brightness, which is very difficult to overcome, will appear at the boundary where the light beam is introduced into the light guide plate. Besides, all the structural parameters are designed solely for the panel of a single dimension; panels of various dimensions require a design of different structural parameters. As such, application of an LED backlight module is greatly limited by the dimensions of the panels.

Currently, a flat field emission illumination module has been developed for the illumination module of LCDs so as to overcome the above-mentioned limitations in application. The structure of a known flat field emission illumination module, as shown in FIG. 1, comprises a top substrate 100 including an anode 101 and a fluorescent layer 102; a bottom substrate 103 including a plurality of cathodes 104, electron emitters 105, and insulating layers 106; and a plurality of supports 107 interposed between the top substrate 100 and the bottom substrate 103 so as to maintain a predetermined vertical distance and vacuum state therebetween. The cathodes 104 and the insulating layers 106 are formed above the bottom substrate 103, and the electron emitters 105 are formed above the cathodes 104. Further, the anode 101 is formed beneath the top substrate 100, and the fluorescent layer 102 is formed beneath the anode 101. By means of such a structure, electrons are emitted from the electron emitters 105, through attraction of the voltage of the anode 101, and impinge upon the fluorescent layer 102, making the fluorescent layer 102 excited and illuminated. As a rule, the top substrate 100 of the flat field emission illumination module has to be a transparent substrate, so that the illumination of the fluorescent layer 102 can pass through the top substrate 100 and form a surface light source.

When a known field emission backlight module is applied to an LCD, because the anode 101 is tightly attached to the film of the LCD, the film and the liquid crystal will become deteriorated when the operating time is lengthy and the anode 101 is overheated under impingement of the electrons. In addition, illumination efficiency of the known field emission backlight module is rather low, because light emission can only be manifested from a direction directly above the fluorescent layer 102, while the light emission from other directions of the fluorescent layer 102 cannot be manifested. Further, because the field emission backlight module is maintained in a vacuum state when packaging, the top and bottom substrates (normally glass substrates) may easily be fractured when the internal and external pressure difference is too great.

Given that flat panel displays are developing toward greater dimensions, higher sophistication and higher definition, it is an urgent issue to overcome the problems inherent in conventional field emission backlight modules, such as inferior cooling effect, low illumination efficiency, and difficulty in packaging.

### SUMMARY OF THE INVENTION

The object of the present invention is to provide a flat field emission illumination module, comprising a top substrate; a bottom substrate including a plurality of cathodes and of electron emitters, wherein the cathodes are located on the top surface of the bottom substrate and the electron emitters are mounted on the cathodes; an anode is interposed between the top and bottom substrates, where the anode is provided at its bottom surface with a plurality of grooves or openings, and where the electron emitters, after assembly of the flat field emission illumination module, are accommodated in the grooves or the openings; and an illumination layer is positioned at the inner surface of the grooves or openings.

Under this structure, electrons are emitted from the electron emitters, through attraction of the voltage of the anode, and impinge upon the illumination layer located in the grooves or openings or the anode, making the illumination layer excited and illuminated. The illumination of the illumination layer is reflected by the anode and thus passes through the bottom substrate for an outward illumination, thereby forming a surface light source.

As compared with the known flat field emission illumination module shown in FIG. 1, the flat field emission illumination module according to the present invention is provided with a plurality of grooves or openings on the anode so as to enlarge the field emission illumination area, to increase the illumination brightness, and to distribute uniformly the electrons emitted to the anode. Moreover, the grooves or openings can reflect from their inner surfaces illumination of illumination layers at various directions, so as to improve light emission and light dispersion, making possible a more uniform illumination.

Further, in the present invention, the anode itself can act as a partition, so that an additional partition is unnecessary in the field emission illumination module. This can avoid the cost incurred for installing a partition in the known field emission illumination module, as shown in FIG. 1, by means of a special manipulator. Besides, according to the present invention, installation of the anode as a partition is particularly easy and no alignment is required.

In the present invention, the anode can be a metal plate or an insulating plate formed at the surface of a metal layer, but preferably is a metal plate. In the case where the anode is a metal plate, electrons are easily released from the anode due to superior electric conductivity for the metal plate; and overheating of the anode can be avoided due to superior heat conduction. In addition, the anode can be formed, optionally, at the backside with a black coating for radiation cooling purpose.

In the flat field emission illumination module according to the present invention, the anode can be an electric conductive plate having a plurality of grooves or openings, where the shape of the cross-section of each groove or opening is not to be limited, but preferably is V-shaped, U-shaped, semicircular, arced, trapezoid, irregular, or a combination thereof.

In the present invention, the grooves of the anode may be apart from one another at an appropriate distance depending upon the requirement of manufacturing process, and similarly the manner that the grooves are arrayed or the number of the grooves is not to be limited so as to achieve an optimal use. As such, the shape of the grooves of the anode according to the present invention is not to be limited, but preferably is elongated, curved, zigzag, irregular, or a combination thereof, in a band-like shape. Similarly, the width of the grooves of the anode is not to be limited, but preferably each of the grooves has an equal width. Nor is it to be limited for the manner that the grooves of the anode are arrayed, preferably the grooves are parallel with one another on the bottom substrate.

Likewise, in the flat field emission illumination module according to the present invention, the openings of the anode may be apart from one another at a distance which can be adjusted, and so the manner that the openings are arrayed or the number of the openings is as required in the manufacturing process so as to achieve an optimal use of the openings. As such, the shape of the openings of the anode according to the present invention is not to be limited, but preferably are circular openings having an equal size.

In the present invention, the shape of the cathodes is not to be limited, but preferably are band-like cathodes, or even more preferably elongated curved, zigzag, or band-like cathodes of irregular shape. The width of the cathodes is not to be limited, but preferably each of the cathodes has an equal width. Nor is it to be limited for the manner that the cathodes are arrayed, preferably the cathodes are parallel with one another on the bottom substrate.

In the present invention, the material used for the electron emitters is not to be limited, but preferably is a carbon-based material, or even more preferably one selected from the group consisting of graphite, diamond, diamond-like carbon, carbon nanotube, C60, or a composition thereof.

It is not intended to limit the color of the light emitted from the flat field emission illumination module according to the present invention, but rely on various illumination materials of the illumination layer which emit a color of light as required. In the present invention, the illumination layer may be divided into several displaying areas or be integrated as a single unit so as to meet an illumination requirement for various colors. The material of the illumination layer according to the present invention is not to be limited, but preferably is fluorescent powder or phosphorescent powder.

Patterned insulating layers may, optionally, be further included in the flat field emission illumination module according to the present invention, where the insulating layers are located at both sides of each cathode so as to provide an electrically insulating function. It is not intended to limit the shape of the insulating layer, though it may be adjusted in compliance with the shape of the cathodes or the manner in which the cathodes are arrayed, but preferably is elongated insulating layers.

The flat field emission illumination module according to the present invention may, optionally, be further included an electric conductive layer at the bottom surface of the top substrate, where the material of the electric conductive layer is not to be limited, but preferably is a transparent electric conductive layer or a metal layer.

In the present invention, a cooling layer located at a top surface of the anode may, optionally, be further included, where the material of the cooling layer is not to be limited, but preferably is a black coating material.

The flat field emission illumination module according to the present invention may, optionally, be further included a plurality of sealant layers located between the top substrate and the bottom substrate so as to provide an internal sealing space for the flat field emission illumination module, where the internal sealing space may be provided therein, optionally, with a degassing agent.

The flat field emission illumination module according to the present invention may be applied to any field that requires illumination, preferably applied to the light source of displays or common flat illumination facilities.

Other objects, advantages, and novel features of the present invention will become more apparent from the following detailed description when taken in conjunction with the accompanying drawings.

### BRIEF DESCRIPTION OF THE DRAWINGS

FIG. 1 is a sectional view of a conventional flat field emission illumination module;

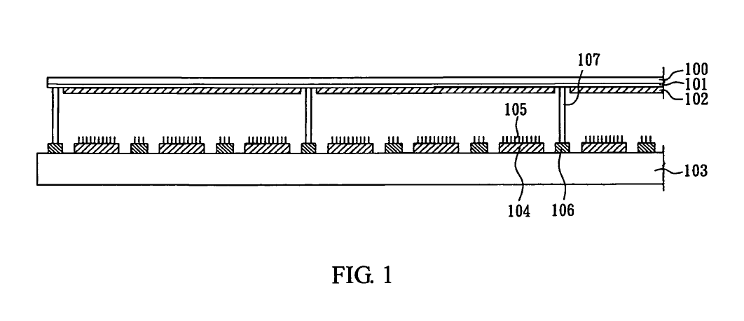

FIG. 2 is a sectional view of a flat field emission illumination module according to a first embodiment of the present invention;

FIG. 3 is a perspective view of an anode shown in FIG. 2;

FIG. 4 is a sectional view of a flat field emission illumination module according to a second embodiment of the present invention;

FIG. 5 is a sectional view of a flat field emission illumination module according to a third embodiment of the present invention;

FIG. 6 is a perspective view of an anode shown in FIG. 5; and

FIG. 7 is a perspective view of an anode shown in a flat field emission illumination module according to a fourth embodiment of the present invention.

### DETAILED DESCRIPTION OF THE PREFERRED EMBODIMENTS

### Embodiment 1

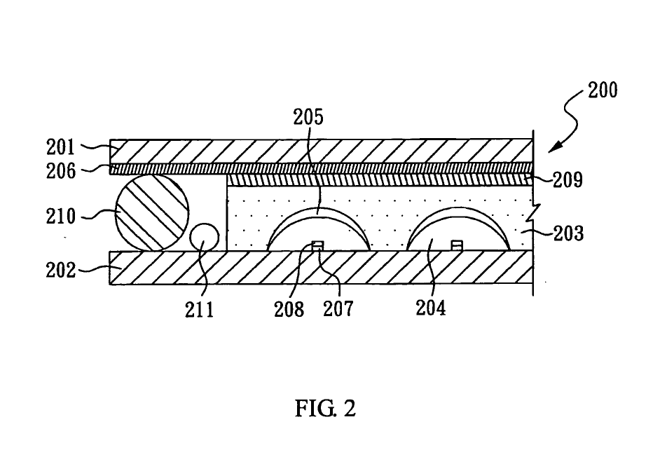

Referring to FIG. 2, a flat field emission illumination module 200 according to the first embodiment of the present invention includes a top substrate 201, a bottom substrate 202, an anode 203 having a plurality of grooves 204, and illumination layers 205 each located inside the groove 204.

As shown in FIG. 2, according to this embodiment, a layer of indium tin oxide, as an electric conductive layer 206 and as a conductor for external connection, is formed underneath the top substrate 201 so that an external power source may provide, through the electric conductive layer 206, an appropriate voltage onto the anode 203. The bottom substrate 202 is provided at a surface thereof a plurality of elongated cathodes 207 on which electron emitters 208 are formed for the purpose of electron emission. In this embodiment, the cathodes 207 are made of silver paste, where the cathodes 207 are equidistantly spaced from and parallel with one another, and where each cathode 207 has the same width. The electron emitters 208 are made of carbon nanotube, where the electron emitters 208, after assembly of the flat field emission illumination module, are accommodated in the grooves 204.

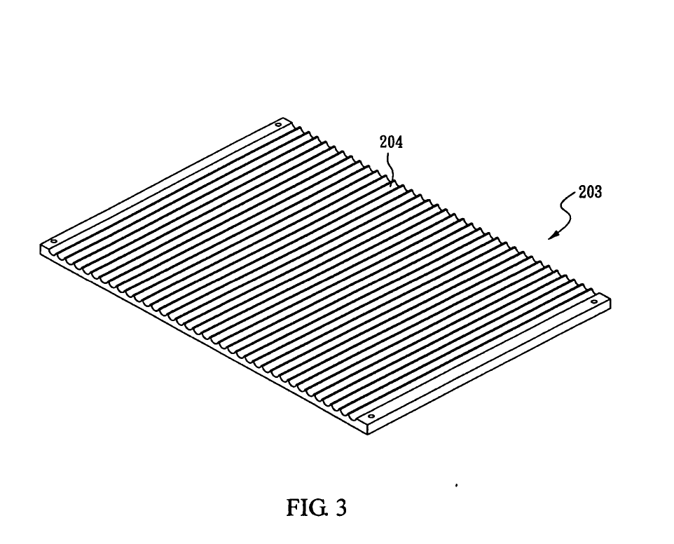

References are also made to FIGS. 2 and 3. The grooves 204 of the anode 203 are each elongated and of a U-shaped cross-section. The grooves 204 are equidistantly spaced from and parallel with one another, where each of the grooves 204 has the same width. In this embodiment, the anode 203 is an aluminum plate 203 on which a black coating 209 is formed for radiation cooling purpose so as to enhance cooling of the anode 203. A fluorescent layer, as an illumination layer 205, is formed at the internal surface of the groove 204 on the anode 203.

After assembly of the flat field emission illumination module 200 according to this embodiment, electron emitters 208 are accommodated in the grooves 204. When the cathode 207 and the anode 203 are each provided with a voltage (the voltage applied to the anode 203 is higher than that of the cathode 207), the electrons emitted from the electron emitters 208 will be attracted by the voltage of the anode 203 and thus impinge on the illumination layers 205 at the internal surface of the grooves 204, so that the illumination layers 205 are excited and illuminated. The illumination from the illumination layer 205 will be reflected by the internal surface of the grooves 204, which then penetrates the bottom substrate 202 and is visible to the outside. Because the groove 204 has a U-shaped cross-section, the illumination from various directions will be dispersed and reflected, making more uniform the illumination of the flat field emission illumination module according to the present invention.

Besides, the flat field emission illumination module 200 comprises a sealant layer 210 located between the top substrate 201 and the bottom substrate 202 so as to provide an internal sealing space for increasing vacuum in flat field emission illumination module 200.

### Embodiment 2

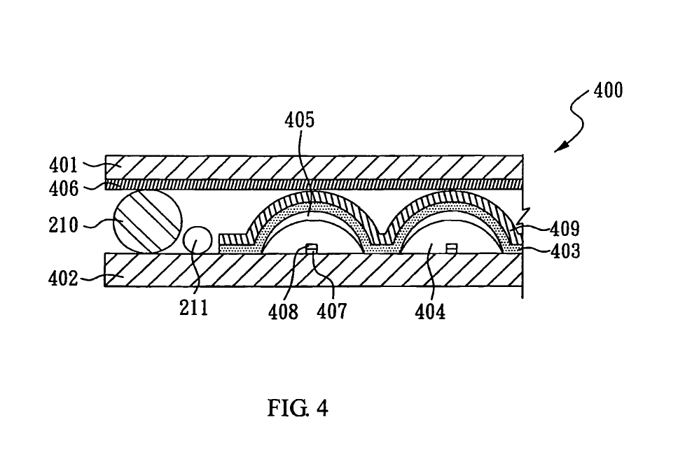

FIG. 4 shows a flat field emission illumination module 400 according to the second embodiment of the present invention. In this embodiment the structure of the flat field emission illumination module 400 is substantially identical with that of the embodiment 1, except for the anode 403.

According to this embodiment, a layer of indium tin oxide, as an electric conductive layer 406, is formed underneath the top substrate 401. The bottom substrate 402 is provided at a surface thereof a plurality of elongated cathodes 407 on which electron emitters 408 are formed for the purpose of electron emission. In this embodiment, the cathodes 407 are made of silver paste, where the cathodes 407 are equidistantly spaced from and paralleled with one another, and where each cathode 407 has the same width. The electron emitters 408 are made of carbon nanotube, where the electron emitters 408, after assembly of the flat field emission illumination module, are accommodated in the grooves 404.

Reference is made to FIG. 4. In the second embodiment the anode 403 is a concave/convex metal plate, wherein the metal is fabricated by a pressing process. Similarly, the grooves 404 of the anode 403 are each elongated and of a U-shaped cross-section. The grooves 404 are equidistantly spaced from and parallel with one another, where each of the grooves 404 has the same width. In this embodiment, the anode 403 is an aluminum plate 403 on which a black coating 409 is formed for radiation cooling purpose so as to enhance cooling of the anode 403. A fluorescent layer 405, as an illumination layer, is formed at the internal surface of the groove 404 on the anode 403.

### Embodiment 3

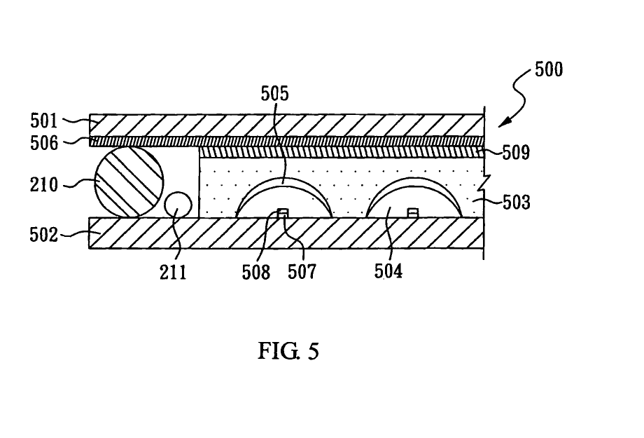

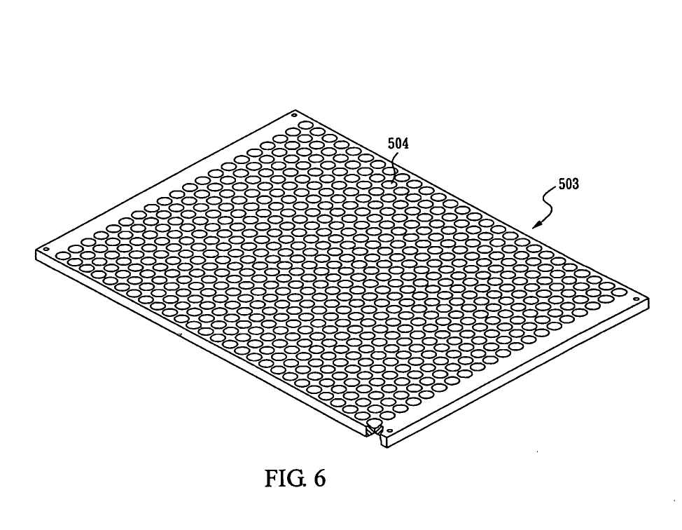

Referring to FIGS. 5 and 6, the flat field emission illumination module 500 according to the third embodiment of the present invention includes an anode 503 having a plurality of openings 504. In this embodiment the openings 504 are circular and each has a U-shaped cross-section. The openings 504 are equidistantly spaced from one another and each has the same dimension. The anode 503 is an aluminum plate 503 on which, as shown in FIG. 5, a black coating 509 is formed for radiation cooling purpose so as to enhance cooling of the anode 503. A fluorescent layer 505, as an illumination layer, is formed at the internal surface of the opening 504 on the anode 503.

As shown in FIG. 5, in this embodiment a layer of indium tin oxide, as an electric conductive layer 506, is formed underneath the top substrate 501. The bottom substrate 502 is provided at a surface thereof a plurality of elongated and discontinuous cathodes 507 which correspond to the openings 504 of the anode 503, where electron emitters 508 are formed on the surfaces of the cathodes 507. In this embodiment, the electron emitters 508, after assembly of the flat field emission illumination module 500, are accommodated in the openings 504. The cathodes 507 are made of silver paste, and the electron emitters 508 are made of carbon nanotube.

### Embodiment 4

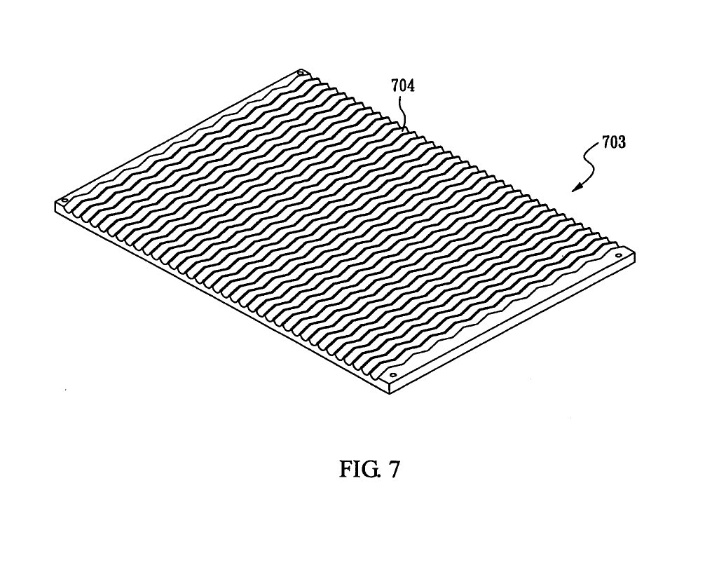

FIG. 7 shows an anode 703 of a flat field emission illumination module (not shown) according to the fourth embodiment of the present invention. As shown in FIG. 7, grooves 704 of the anode 703 may be of continuous zigzag band-like shape, and be equidistantly spaced from and parallel with one another, where the grooves 704 are each of equal width. In this embodiment, the groove 704 has a U-shaped cross-section. After assembling the anode 703 into the flat field emission illumination module according to this embodiment, the configuration and location of cathodes (not shown) need to correspond to the grooves 704 of the anode 703 so as to accommodate electron emitters (not shown) in the grooves 704.

Although the present invention has been explained in relation to its preferred embodiments, it is to be understood that many other possible modifications and variations can be made without departing from the scope of the invention as hereinafter claimed.

What is claimed is:

1. A flat field emission illumination module, comprising:
a top substrate;
a bottom substrate, comprising a plurality of cathodes and of electron emitters, wherein the cathodes are located on the top surface of the bottom substrate and the electron emitters are respectively mounted on the cathodes;
an anode interposed between the top and bottom substrates, where the anode is provided at its bottom surface with a plurality of grooves or openings, and where the electron emitters, after assembly of the flat field emission illumination module, are accommodated in the grooves or the openings; and
an illumination layer, positioned at the inner surface of the grooves or the openings.

2. The flat field emission illumination module as claimed in claim 1, wherein the shape of the cross-section of the grooves is selected from the group consisting of V-shape, U-shape, semicircle, arc, trapezoid, irregular shape, or a combination thereof.

3. The flat field emission illumination module as claimed in claim 1, wherein the shape of the grooves is selected from the group consisting of elongated shape, curved shape, zigzag shape, irregular shape, or a combination thereof.

4. The flat field emission illumination module as claimed in claim 1, wherein each of the grooves has an equal width.

5. The flat field emission illumination module as claimed in claim 1, wherein the grooves are equidistantly spaced from one another.

6. The flat field emission illumination module as claimed in claim 1, wherein the grooves are parallel with one another.

7. The flat field emission illumination module as claimed in claim 1, wherein the shape of the cross-section of the openings is selected from the group consisting of V-shape, U-shape, semicircle, arc, trapezoid, irregular shape, or a combination thereof.

8. The flat field emission illumination module as claimed in claim 1, wherein the shape of the openings is circular.

9. The flat field emission illumination module as claimed in claim 1, wherein the anode is made of metal.

10. The flat field emission illumination module as claimed in claim 1, wherein the anode is made of aluminum.

11. The flat field emission illumination module as claimed in claim 1, wherein the voltage applied to the anode is higher than that to the cathode.

12. The flat field emission illumination module as claimed in claim 11, wherein the flat field emission illumination module further comprises an electric conductive layer at the bottom surface of the top substrate.

13. The flat field emission illumination module as claimed in claim 12, wherein the electric conductive layer is a transparent electric conductive layer or a metal layer.

14. The flat field emission illumination module as claimed in claim 1, wherein the flat field emission illumination module further comprising a cooling layer located at the top surface of the anode.

15. The flat field emission illumination module as claimed in claim 14, wherein the cooling layer is made of black coating material.

16. The flat field emission illumination module as claimed in claim 1, further comprising at least one sealant layer located between the top substrate and the bottom substrate so as to provide an internal sealing space for the flat field emission illumination module.

17. The flat field emission illumination module as claimed in claim 16, further comprising at least one degassing agent in the internal sealing space of the flat field emission illumination module.

18. The flat field emission illumination module as claimed in claim 1, wherein the cathode is made of metal.

19. The flat field emission illumination module as claimed in claim 1, wherein the electron emitters are made of carbon nanotube, diamond or diamond-like carbon.

20. The flat field emission illumination module as claimed in claim 1, wherein the illumination layer is a layer of fluorescent powder or of phosphorescent powder.
